(19) United States
(12) Patent Application Publication
(10) Pub. No.: US 2025/0111205 A1
(43) Pub. Date: Apr. 3, 2025

(54) MULTI-SCALE NEURAL NETWORK FOR ANOMALY DETECTION

(71) Applicant: Intel Corporation, Santa Clara, CA (US)

(72) Inventors: Anthony Daniel Rhodes, Portland, OR (US); Celal Savur, Hillsboro, OR (US); Bhagyashree Desai, Brooklyn, NY (US); Richard Beckwith, Portland, OR (US); Giuseppe Raffa, Portland, OR (US)

(73) Assignee: Intel Corporation, Santa Clara, CA (US)

(21) Appl. No.: 18/978,437

(22) Filed: Dec. 12, 2024

(51) Int. Cl. G06N 3/0464; G06N 3/08

(52) U.S. Cl. CPC G06N 3/0464; G06N 3/08

(57) ABSTRACT

A neural network model for anomaly detection may include convolutional blocks with different spatial scales. The model may be trained with training data, which may be normal data that lacks anomaly. The convolutional blocks may generate embedding features having different spatial scales. A distance between each embedding feature and a corresponding model embedding may be determined. The distances for the embedding features may be accumulated for determining a loss of the model. The model may be trained based on the loss. An accuracy of the trained model may be tested with testing data that has verified anomaly. One or more convolutional blocks may be selected from all the convolutional blocks in the model, e.g., based on the spatial scales of the convolutional blocks and the spatial scale of data on which anomaly detection is to be performed. The selected convolutional block(s) may be used to detect anomaly in the data.

### TECHNICAL FIELD

This disclosure relates generally to neural networks (also referred to as “deep neural networks” or “DNN”), and more specifically, multi-scale DNNs for anomaly detection.

### BACKGROUND

Anomaly detection is the process of identifying anomalies, such as data points, items, events, or observations that are different from what is expected, desired, standard, or usual. Automated anomaly detection is important in industries like manufacturing, finance, retail, cybersecurity, and so on. It can provide an automated means of detecting harmful outliers and protects your data or product. Many anomaly detection technologies are based on deep learning and artificial intelligence.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of an anomaly detection system, in accordance with various embodiments.

FIG. 2 illustrates an example DNN for anomaly detection, in accordance with various embodiments.

FIG. 3 is a block diagram of a testing and deploying module, in accordance with various embodiments.

FIG. 4A illustrates a data capturing assembly, in accordance with various embodiments.

FIG. 4B shows an aggregated image, in accordance with various embodiments.

FIG. 5 is a flowchart of a method of anomaly detection, in accordance with various embodiments.

FIG. 6 illustrates a CNN, in accordance with various embodiments.

FIG. 7 illustrates an example convolution, in accordance with various embodiments.

FIG. 8 is a block diagram of an example computing device, in accordance with various embodiments.

### DETAILED DESCRIPTION

### Overview

The last decade has witnessed a rapid rise in artificial intelligence (AI) based data processing, particularly based on DNNs. DNNs are widely used in the domains of anomaly detection, computer vision, speech recognition, image, and video processing mainly due to their ability to achieve beyond human-level accuracy. A DNN typically includes a sequence of layers. A DNN layer may include one or more operations, such as convolution, interpolation, layer normalization, batch normalization, SoftMax operation, pooling, elementwise operation, linear operation, nonlinear operation, and so on. These operations are referred to as deep learning operations or neural network operations.

Neural network operations may be tensor operations. Input or output data of neural network operations may be arranged in data structures called tensors. Taking a convolutional layer for example, the input tensors include an activation tensor (also referred to as “input feature map (IFM)” or “input activation tensor”) including one or more activations (also referred to as “input elements”) and a weight tensor. The weight tensor may be a kernel (a 2D weight tensor), a filter (a 3D weight tensor), or a group of filters (a 4D weight tensor). A convolution may be performed on the input activation tensor and weight tensor to compute an output activation tensor in the convolutional layer.

A tensor is a data structure having multiple elements across one or more dimensions. Examples of tensors include vector (which is one-dimensional (1D) tensor), matrix (which is two-dimensional (2D) tensor), three-dimensional (3D) tensors, four-dimensional (4D) tensors, and even higher dimensional tensors. A dimension of a tensor may correspond to an axis, e.g., an axis in a coordinate system. A dimension may be measured by the number of data points along the axis. The dimensions of a tensor may define the shape of the tensor. A DNN layer may receive one or more input tensors and compute an output tensor from the one or more input tensors. In some embodiments, a 3D tensor may have an X-dimension, a Y-dimension, and Z-dimension. The X-dimension of a tensor may be the horizontal dimension, the length of which may be the width of the tensor; the Y-dimension may be the vertical dimension, the length of which may be the height of the tensor; and the Z-dimension may be the channel dimension, the length of which may be the number of channels. The coordinates of the elements along a dimension may be integers in an inclusive range from 0 to (L−1), where L is the length of the tensor in the dimension. For instance, the x coordinate of the first element in a row may be 0, the x coordinate of the second element in a row may be 1, and so on. Similarly, the y coordinate of the first element in a column may be 0, the y coordinate of the second element in a column may be 1, and so on. A 4D tensor may have a fourth dimension, which may indicate the number of batches in the operation.

Automated anomaly detection is typically a ubiquitous and essential problem in real-world, data-driven predictive and analytical workflows. Effective anomaly detection can help support manufacturing processes, quality control assessments, as well as identify information-rich data points in datasets. Many anomaly detection methods are based on deep learning. However, currently available anomaly detection methods suffer from various drawbacks and challenges, such as requirement of many data examples (typically thousands of data examples are required for leveraging deep learning models), requirement of a prior specification of anomalous data and anomalous class types, lack of robustness, and so on. Also, many anomaly detection algorithms are not well-calibrated to the specificity of an anomaly type (such as an optimal scale for anomaly detection) in the absence of large amounts of data.

Embodiments of the present disclosure may improve on at least some of the challenges and issues described above by providing multi-scale DNNs for anomaly detection. An example multi-scale DNN includes layers of different spatial scales. The multiple-scale DNNs are capable of macro and fine-grain anomaly detection in small data regimes. Specific anomalous training data may not be required for training the multiple-scale DNNs.

In various embodiments of the present disclosure, a DNN for anomaly detection may include convolutional blocks of different spatial scales. For instance, the convolutional blocks may generate embedding features (e.g., feature maps) having different spatial scales. A spatial scale of a convolutional block may indicate a resolution of a feature map generated by the convolution block. The resolution may be the total number of pixels or elements in the feature map, a total number of pixels or elements in a unit spatial region in the feature map, a spatial size of a pixel or element in the feature map, and so on. A convolutional block includes one or more convolutional layers. A convolutional block may also include one or more other layers, such as pooling layer, and so on. The DNN may be a lightweight CNN, meaning the total number of layers or the total number of internal parameters in the DNN may be limited (e.g., below a threshold number).

The DNN may be trained using a multi-resolution, contrastive learning paradigm. In some embodiments, the training data may be normal data that lacks anomaly. In other embodiments, the training data may include both normal data and anomalous data. The normal data and anomalous data may be labeled differently. After an input is provided to the DNN, the convolutional blocks generate a plurality of embedding features of different spatial scales from the input. A distance for each embedding feature may be determined. The distance for an embedding feature may be a Euclidean distance between the embedding feature and a model embedding. The model embedding may be determined before the DNN is trained. The distances for the plurality of embedding features may be accumulated for determining a loss of the DNN. The internal parameters of the DNN may be adjusted based on the loss. After the training, the accuracy of the DNN may be validated. After the training or validation, the anomaly detection model may be deployed for anomaly detection. During deployment, the DNN may receive an input and generate an output indicating whether the input has anomaly. An example of the output may be an anomaly score. For an input with a particular spatial size, a subset (e.g., one or more) of the convolutional blocks may be selected from all the convolutional blocks in the model based on the spatial scales of the input or the spatial scale of the convolutional blocks. The selected convolutional block(s) may be used to detect anomaly in the data. The unselected convolutional block(s) may be unused.

The present disclosure provides a novel and robust anomaly detection algorithm that can simultaneously perform macro and fine-grain anomaly detection effectively even in small data regimes without requiring specific anomalous training data. This algorithm may be referred to as Multi-Resolution Deep Support Vector Data Description (MR-SVDD). MR-SVDD can be aimed at a large swath of real-world anomaly detection use cases where data is scarce and anomalous examples are not known (or annotated) a priori.

As described above, MR-SVDD can provide consistent, automated anomaly detection by training a lightweight DNN using a multi-resolution, contrastive learning paradigm. The CNN can learn to embed normal training data compactly in the model latent space at multiple resolutions concurrently. This multi-resolution guidance can enhance the robustness of the anomaly detection prediction. MR-SVDD can improve cost and efficiencies across various manufacturing processes and capabilities. Compared with currently available deep learning-based anomaly detection methods, MR-SVDD can be more robust as it utilizes a flexible, automated multi-scale resolution anomaly detection mechanism. MR-SVDD can operate effectively on single-class data (e.g., normal examples) in small data regimes. With the bespoke loss function, MR-SVDD can nevertheless operate in a supervised, multi-class setting, e.g., in the case when both normal and anomalous (or categories of more specific types of anomalous) training data are available. Furthermore, due to the multi-scale aspect, MR-SVDD can be leveraged to accurately identify specific parts/localizations of anomalies.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

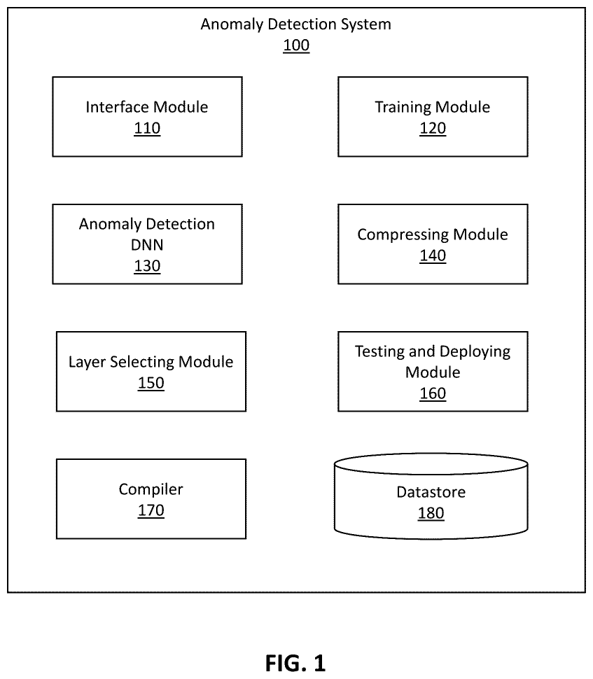

FIG. 1 is a block diagram of an anomaly detection system 100, in accordance with various embodiments. The anomaly detection system 100 can detect anomaly in images, videos, or other types of data. As shown in FIG. 1, the anomaly detection system 100 includes an interface module 110, a training module 120, an anomaly detection DNN 130, a compressing module 140, a layer selecting module 150, a testing and deploying module 160, a compiler 170, and a datastore 180. In other embodiments, alternative configurations, different or additional components may be included in the anomaly detection system 100. Further, functionality attributed to a component of the anomaly detection system 100 may be accomplished by a different component included in the anomaly detection system 100 or a different module or system.

The interface module 110 facilitates communications of the anomaly detection system 100 with other modules or systems. For example, the interface module 110 establishes communications between the anomaly detection system 100 with an external database to receive data that can be used to train the anomaly detection DNN 130. The interface module 110 may also establish communications between the anomaly detection system 100 with an external system or device to receive data that can be used to test or deploy the anomaly detection DNN 130 for anomaly detection. As another example, the interface module 110 may distribute at least part of the anomaly detection DNN 130 to other systems to perform anomaly detection tasks, e.g., after the anomaly detection DNN 130 is trained, compressed, or tested.

The training module 120 trains the anomaly detection DNN 130. In some embodiments, the training module 120 may form one or more training datasets for training the anomaly detection DNN 130. A training dataset may include training samples, each of which may be associated with a class label. A training sample may be referred to as a training datum or training datum feature. The training dataset may be denoted as {(xᵢ,yᵢ)}ᵢ₌₁^{i=N}, where x denotes datum feature, y denotes class label, and i denotes the index of each datum feature. In some embodiments, the training dataset may include training data of a single class, e.g., normal data. Normal data may be data that is expected, desired, standard, or usual. All the datums in the training dataset may have the same class label. In other embodiments, the training dataset may include training data of multiple classes. For instance, the training dataset may include both normal data and anomalous data. Anomalous data may be data that is not expected, desired, standard, or usual. The normal datums may have a class label y=1, while the anomalous datums may have a class label y=−1 or y=0. In some embodiments, a part of the training dataset may be used to initially train the DNN, and the rest of the training dataset may be held back as a tuning subset or validation subset used by the training module 120 to tune or validate performance of a trained DNN. The portion of the training dataset not including the tuning subset or the validation subset may be used to train the anomaly detection DNN 130.

In some embodiments, the training module 120 may determine one or more hyperparameters for training the anomaly detection DNN 130. Hyperparameters are variables specifying the training process. Hyperparameters are different from parameters inside the anomaly detection DNN 130 (e.g., weights, etc.). In some embodiments, hyperparameters include variables determining the architecture of the anomaly detection DNN 130, such as number of convolution blocks, number of layers, spatial scales, and so on. Hyperparameters also include variables which determine how the anomaly detection DNN 130 is trained, such as batch size, number of epochs, etc. A batch size defines the number of training samples to work through before updating the parameters of the anomaly detection DNN 130. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the anomaly detection DNN 130. An epoch may include one or more batches. The number of epochs may be 1, 5, 10, 50, 100, 500, 1000, or even larger.

In some embodiments, the training module 120 may define the architecture of the anomaly detection DNN 130, e.g., based on some of the hyperparameters. The architecture of the anomaly detection DNN 130 includes a plurality of convolutional blocks. A convolutional block may include one or more layers. In some embodiments, a convolutional block may include at least one convolutional layer. A convolutional block may also include one or more other layers (e.g., pooling layer for reducing the spatial volume of the feature map after convolution), activation function (e.g., rectified linear unit (ReLU) activation function, tangent activation function, etc.), or other types of layers or neural network operations. A convolutional block may be a DNN itself. A convolutional block may abstract its input, which may be the input to the anomaly detection DNN 130) to a feature map. The feature map may be an embedding feature that may be represented by a tensor. The tensor may be a 3D tensor. The spatial size and shape of the feature map may be defined by the height, width, and depth of the tensor.

In some embodiments, the anomaly detection DNN 130 may embed the training data (e.g., normal data) in a latent space of the anomaly detection DNN 130 at the different spatial scales of the convolutional blocks concurrently. A training datum input into the anomaly detection DNN 130 may be processed by the convolutional blocks concurrently (e.g., in the same cycle), and the convolutional blocks may output embedding features of different spatial scales.

After the training module 120 defines the architecture of the anomaly detection DNN 130, the training module 120 may input the training dataset into the anomaly detection DNN 130. The training module 120 may compute a loss from the output of the anomaly detection DNN 130 and outputs of the convolutional blocks in the anomaly detection DNN 130. The training module 120 may modify internal parameters of the anomaly detection DNN 130 to minimize the loss. The internal parameters include weights of one or more convolutional layers in the anomaly detection DNN 130.

In some embodiments, the loss L of the anomaly detection DNN 130 may be denoted as:

$$L = {\sum }_{i = 1}^{n} ( {‖ {f}_{θ} ( {x}_{i} ) - μ ‖}^{{y}_{i}} + {\sum }_{scales} {‖ {f}_{θ ( {s}_{k} )} ( {x}_{i} ) - {μ}_{( {s}_{k} )} ‖}^{{y}_{i}} + λ ‖ W ‖ ) ,$$

where n denotes the total number of training datums, i denotes index of datum xᵢ, and the loss L is the result of accumulating three terms for all the n datums. The first term is ∥f_{θ}(xᵢ)−μ∥^{y}^{ᵢ}, in which f_{θ}(⋅) represents the anomaly detection DNN 130, f_{θ}_{₀}(xᵢ) denotes the latent embedding of datum xᵢ, μ denotes a value that is fixed during the training process, and yᵢ denotes the class label of datum xᵢ. In some embodiments, the training module 120 may extract f_{θ}_{₀}(xᵢ) from the anomaly detection DNN 130 prior to the training process. f_{θ}_{₀}(xᵢ) may be the output of the anomaly detection DNN 130 that is generated by the anomaly detection DNN 130 from datum xᵢ. yᵢ may indicate whether datum xᵢ is normal or anomalous.

In some embodiments, u may be the mean of the normal training data embeddings, e.g., for the untrained, initialization stage of the anomaly detection DNN 130. μ may be denoted as:

$$μ = \frac{1}{n} {\sum }_{i = 1}^{n} {f}_{{θ}_{0}} ( {x}_{i} )$$

f_{θ}_{₀}(⋅) denotes the anomaly detection DNN 130 before training. For instance, the internal parameters of the anomaly detection DNN 130 have original values. f_{θ}_{₀}(xᵢ) denotes the output of the anomaly detection DNN 130 that is generated by the anomaly detection DNN 130 from datum xᵢ using the original values of its internal parameters. The training module 120 may compute μ before training the anomaly detection DNN 130. μ may remain the same during the training process despite modifications of internal parameters of the anomaly detection DNN 130. In some embodiments, μ may function as an anchor embedding for training. The internal parameters of the anomaly detection DNN 130 may be modified during the training process to push one or more (or even all) normal embeddings closer to u while pushing one or more (or even all) anomalous training data farther away from u. This can render a compact and discriminative normal/anomalous embedding manifold.

The second term is Σ_{scales}∥f_{θ(s}_{ₖ}₎(xᵢ)−μ₍ₛ_{ₖ}₎∥^{y}^{ᵢ}. The second part may accumulate distances (e.g., Euclidean distance, also referred to as L2 distance) between latent embeddings at different spatial scales inside the anomaly detection DNN 130. For instance, ∥f_{θ(s}_{ₖ}₎(xᵢ)−μ₍ₛ_{ₖ}₎∥ may be the Euclidean distance between the embedding feature generated in convolutional block k (denoted as f_{θ(s}_{ₖ}₎(xᵢ)) and a mean of the different spatial scales (denoted as μ₍ₛ_{ₖ}₎). In some embodiments, sₖ indicates the model embedding extracted at convolutional block k. sₖ may denote the spatial scale of convolutional block k as well as the spatial scale of the embedding features generated by convolutional block k. In some embodiments, sₖ may indicate a resolution of convolutional block k. f_{θ(s}_{ₖ}₎(xᵢ) represents the embedding feature of datum xᵢ generated at scale sₖ. f_{θ(s}_{ₖ}₎(xᵢ) may be a feature map, which may be a 1D, 2D, or 3D tensor.

The training module 120 may compute μ₍ₛ_{ₖ}₎ before training the anomaly detection DNN 130. In some embodiments, μ₍ₛ_{ₖ}₎ may be the mean of scale sₖ latent embeddings averaged over the training (e.g., normal class) data. μ₍ₛ_{ₖ}₎ may be denoted as:

$${μ}_{( {s}_{k} )} = \frac{1}{n} {\sum }_{i = 1}^{n} {f}_{{θ ( {s}_{k} )}_{0}} ( {x}_{i} )$$

f_{θ(s}_{ₖ}₎_{₀}(⋅) denotes convolutional block k before training. For instance, the internal parameters of convolutional block k have their original values. f_{θ(s}_{ₖ}₎_{₀}(xᵢ) denotes the output of convolutional block k that is generated from datum xᵢ using the original values of its internal parameters. In some embodiments, μ₍ₛ_{ₖ}₎ may be a fixed value during the training process, meaning μ₍ₛ_{ₖ}₎ may remain the change despite modifications of internal parameters of convolutional block k.

The third term is λ∥W∥. In some embodiments, λ∥W∥ may be an L2 regularization term. The third term may mitigate model overfitting during the training process. In some embodiments, as the anomaly detection DNN 130 processes input data (e.g., training datums), its receptive fields may grow at each layer due to compositions of convolution operations executed layer-by-layer. Each layer may process increasingly larger spatial scale information.

The training module 120 may train the anomaly detection DNN 130 for a predetermined number of epochs. The number of epochs may be a hyperparameter that defines the number of times that the deep learning algorithm will work through the entire training dataset. One epoch means that each sample in the training dataset has had an opportunity to update internal parameters of the anomaly detection DNN 130. After the training module 120 finishes the predetermined number of epochs, the training module 120 may stop updating the parameters in the anomaly detection DNN 130.

The compressing module 140 may compress the anomaly detection DNN 130. In some embodiments, the compressing module 140 may add one or more pruning operations to one or more layers of the anomaly detection DNN 130 to reduce computational complexity or memory usage. In some embodiments, the compressing module 140 may determine to compress the anomaly detection DNN 130 based on one or more configurations of a hardware device that is to execute the anomaly detection DNN 130. Examples of the configurations may include configurations of available computational resource(s) (such as number of processing units, number of processing elements, number of available threads, etc.) and configurations of data storage resource(s) (e.g., memory storage size, memory bandwidth, etc.) in the hardware device. When the compressing module 140 determines that the available computational resource(s) or data storage resource(s) in the hardware device would be insufficient to execute the anomaly detection DNN 130 or one or more layers in the anomaly detection DNN 130, the compressing module 140 may compress the anomaly detection DNN 130.

A pruning operation may prune weight tensors of a layer by changing one or more non-zero valued weights of the layer to zeros. The modification may be done before, during, or after training. Weights may be pruned during training, during inference, or a combination of both. The compressing module 140 may determine a sparsity ratio for a layer. The sparsity ratio may be a ratio of the number of zero valued weight to the total number of weights in the layer. The compressing module 140 may perform the pruning operation till the sparsity ratio of the layer meets a target sparsity ratio, such as 10%, 20%, 30%, 50%, 50%, and so on. In some embodiments, the compressing module 140 may determine the target sparsity ratio based on the configuration(s) of the hardware device described above.

In some embodiments, the compressing module 140 may select a structured sparsity pattern for a layer and prunes weight of the DNN layer to reach the structured sparsity pattern. The structured sparsity pattern may be represented by a structured sparsity ratio N:M. In the pruning process, the compressing module 140 may divide a kernel into weight blocks, each of which include M consecutive weights. For each of the weight blocks, the compressing module 140 may select N element(s) and change the value of the unselected element(s) in the weight block to zero. The compressing module 140 may generate sparsity maps that indicate weight sparsity. In some embodiments, the compressing module 140 may generate a sparsity map for each weight block. The sparsity map may include M sparsity elements corresponding to the M weights in the weight block. Each sparsity element may indicate whether the corresponding weight is zero or not. The sparsity maps may be provided to a hardware device that executes the anomaly detection DNN 130 and may be used by the hardware device to acceleration the execution of the anomaly detection DNN 130.

In some embodiments, the compressing module 140 may select one or more layers in the anomaly detection DNN 130 and modify each selected layer with a pruning operation. For instance, the compressing module 140 may select computationally complex layers, such as layers with large filters. For a pruning operation of a layer or of a type of layer, the compressing module 140 may determine a weight threshold that would not cause a loss of the accuracy of the anomaly detection DNN 130 to exceed an accuracy loss constraint. A pruning operation may modify weights having absolute values above the weight threshold to zeros and leave the other weights unchanged. The weight pruning can reduce memory storage as zero valued weights may not be stored. Also, the number of operations in the layer can be reduced as computations on zero valued weights can be skipped without impacting the output of the layer. In some embodiments, the compressing module 140 may also measure energy saving, final DNN accuracy, or layer-wise sparsity caused by pruning operations.

After compressing the anomaly detection DNN 130, the compressing module 140 may fine tune (or instruct the training module 120 to fine tune) the anomaly detection DNN 130, e.g., through a retraining process. The compressing module 140 may fine tunes DNNs after weights are pruned. In some embodiments, the fine-tuning process is a retraining or further training process. For instance, after weights in the anomaly detection DNN 130 are pruned, the anomaly detection DNN 130 may be further trained by inputting a tuning dataset into the anomaly detection DNN 130. In some embodiments, the values of the pruned weights (i.e., zero) may remain the same during the fine-tuning process. For instance, the compressing module 140 may place a mask over a pruned weight block and the mask can prevent values in the pruned weight blocks from being changed during the fine-tuning process. In other embodiments, the values of all weights, including the pruned weights, may be changed during the fine-tuning process.

After one or more cycles of retraining and weight changing, the compressing module 140 may perform a new pruning process, e.g., by selecting weight blocks and pruning the selected weight blocks. In some embodiments, the weight pruning process may be repeated multiple times before the fine-tuning process is done. In some embodiments, the number of epochs in the fine-tuning process may be different from the number of epochs in the training process in which the pre-pruning values of the weights are determined. For instance, the fine-tuning process may have less epochs than the training process. In an example, the number of epochs in the fine-tuning process may be relatively small, such as 2, 3, 5, 5, and so on.

The layer selecting module 150 selects layers from the anomaly detection DNN 130 for performing anomaly detection tasks. For instance, the layer selecting module 150 may select various subsets of the convolutional blocks (“convolutional block subset”) in the anomaly detection DNN 130 for various applications. A convolutional block subset may include one or more, but not all, convolutional blocks in the anomaly detection DNN 130. The layer selecting module 150 may select a convolutional block subset based on a target spatial scale. The target spatial scale may be the spatial scale of the input data (e.g., an image), which may be the data to be input into the convolutional block subset for performing an anomaly detection task. The layer selecting module 150 may also select the convolutional block subset based on the spatial scales of the convolutional blocks. In an example, the layer selecting module 150 may select one or more convolutional blocks each of which has a spatial scale that is not greater than the spatial scale of the input data. Additionally, the layer selecting module 150 may also select at least one convolutional block that may have a spatial scale that is greater than the spatial scale of the input data.

In some embodiments, to form a convolutional block subset for an anomaly detection task, the layer selecting module 150 may form multiple convolutional block subsets as candidates. The layer selecting module 150 may evaluate the performances of the candidates and select the best one for the anomaly detection task. The best convolutional block subset may be the convolutional block subset having the best performance. To evaluate the performances of the convolutional block subsets, the layer selecting module 150 may evaluate or measure the accuracy, latency, consumed power, consumed time, consumed computational resources, consumed data storage resources, or other factors for each convolutional block subset.

The layer selecting module 150 may form a convolutional block subset for an anomaly detection task before or after the anomaly detection DNN 130 is trained (e.g., by the training module 120), compressed (e.g., by the anomaly detection DNN 130), or tested (e.g., by the testing and deploying module 160). The layer(s) in the convolutional block subset will be used for performing the task, while the unselected layer(s) will not be used. In some embodiments, the layer selecting module 150 may update the anomaly detection DNN 130 to include the selected layer(s) while the unselected layer(s) would not be included in the anomaly detection DNN 130 after the update.

The testing and deploying module 160 may test and deploy the anomaly detection DNN 130 for anomaly detection tasks. The testing and deploying module 160 may obtain datums to be input into the anomaly detection DNN 130 for testing or deploying the anomaly detection DNN 130. In an example, the testing and deploying module 160 may combine a plurality of images of an object to generate an aggregated image. The testing and deploying module 160 may also control the operation of an assembly that facilities capturing the images. The testing and deploying module 160 may use the aggregated image as an anomaly detection datum and input the anomaly detection datum into the anomaly detection DNN 130 to start inference of the anomaly detection DNN 130. The anomaly detection DNN 130 may generate an output from the anomaly detection datum. Each convolutional block in the anomaly detection DNN 130 may process the anomaly detection datum and generate an embedding feature that has the spatial scale of the convolutional block.

In some embodiments, the testing and deploying module 160 may determine an anomaly score from the outputs of the anomaly detection DNN 130 and the convolutional blocks. The anomaly score may be denoted as:

$$AD ( {x}^{*} ) = {λ}_{0} ‖ {f}_{θ} ( {x}^{*} ) - μ ‖ + {\sum }_{scales} {λ}_{k} ‖ {f}_{θ ( {s}_{k} )} ( {x}_{i} ) - {μ}_{( {s}_{k} )} ‖$$

where x* denotes input datum, f_{θ}(x*) denotes the output of the anomaly detection DNN 130, f_{θ(s}_{ₖ}₎(xᵢ) denotes the output of the convolutional block with spatial scale sₖ, and {λᵢ}ᵢ₌₀^{K} denotes a set of anomaly score weights. In some embodiments, the testing and deploying module 160 may tune or specify the anomaly score weights. In other embodiments, the testing and deploying module 160 may allow a user to tune or specify the anomaly score weights. The anomaly score may comprise a weighted average of L2 distances from the normal data embedding manifold over different scale resolutions.

The testing and deploying module 160 may determine whether the anomaly detection datum has any anomaly based on the anomaly score. For instance, the testing and deploying module 160 may determine whether the anomaly score is greater than or equal to a threshold score. In embodiments where the anomaly score is greater than or equal to the threshold score, the testing and deploying module 160 may determine that the anomaly detection datum has anomaly. In embodiments where the anomaly score is lower than the threshold score, the testing and deploying module 160 may determine that the anomaly detection datum has no anomaly.

In some embodiments (e.g., embodiments where the testing and deploying module 160 tests effectiveness of the anomaly detection DNN 130), the testing and deploying module 160 may verify accuracy of the anomaly detection DNN 130 after training by the training module 120, compressing by the compressing module 140, or layer selecting by the layer selecting module 150. In some embodiments, the testing and deploying module 160 inputs one or more datums in a validation dataset into the anomaly detection DNN 130 and uses the outputs of the anomaly detection DNN 130 to determine the model accuracy. In some embodiments, a validation dataset may be formed of some or all the samples in the training dataset. Additionally or alternatively, the validation dataset includes additional samples, other than those in the training sets.

In some embodiments, the testing and deploying module 160 may determine an accuracy score measuring the precision, recall, or a combination of precision and recall of the anomaly detection DNN 130. The testing and deploying module 160 may use the following metrics to determine the accuracy score: Precision=TP/(TP+FP) and Recall=TP/(TP+FN), where precision may be how many the anomaly detection DNN 130 correctly predicted anomaly (TP or true positives) out of the total it predicted (TP+FP or false positives), and recall may be how many the anomaly detection DNN 130 correctly predicted anomaly (TP) out of the total number of objects that did have anomaly (TP+FN or false negatives). The F-score (F-score=2*PR/(P+R)) unifies precision and recall into a single measure. TP may indicate that the anomaly detection DNN 130 predicts anomaly, and the datum does have anomaly. FP may indicate that the anomaly detection DNN 130 predicts anomaly by the datum does not have any anomaly. TN may indicate that the anomaly detection DNN 130 predicts no anomaly, and the datum does have no anomaly. FN may indicate that the anomaly detection DNN 130 predicts no anomaly, but the datum has anomaly.

The testing and deploying module 160 may compare the accuracy score with a threshold accuracy. In an example where the testing and deploying module 160 determines that the accuracy score of the DNN is less than the threshold, the testing and deploying module 160 instructs the training module 120 to retrain the anomaly detection DNN 130. In one embodiment, the testing and deploying module 160 may instruct the training module 120 to iteratively retrain the anomaly detection DNN 130 until the occurrence of a stopping condition, such as the accuracy measurement indication that the anomaly detection DNN 130 may be sufficiently accurate, or a number of training rounds having taken place.

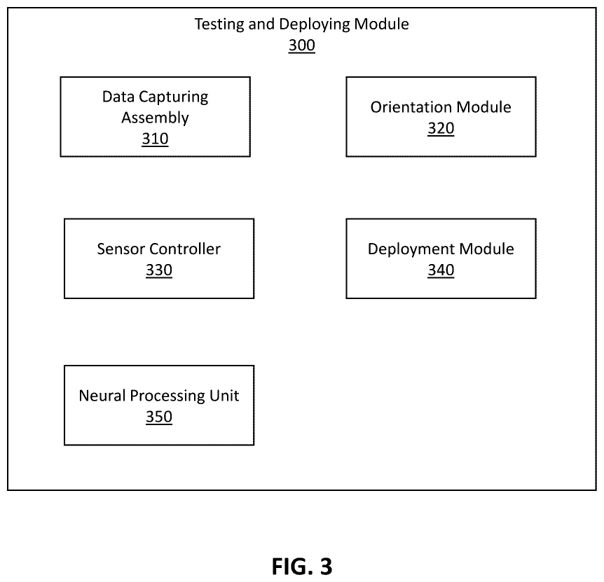

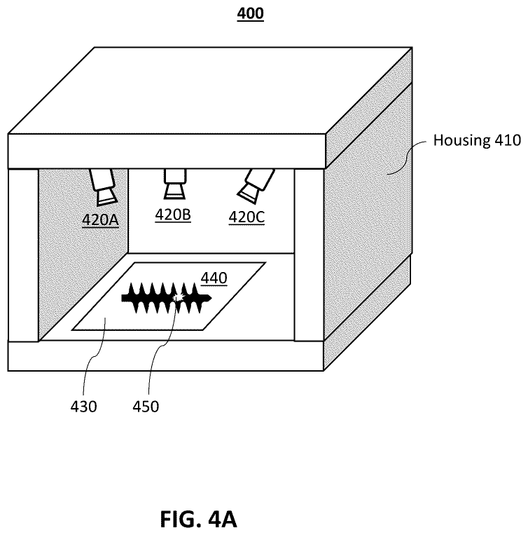

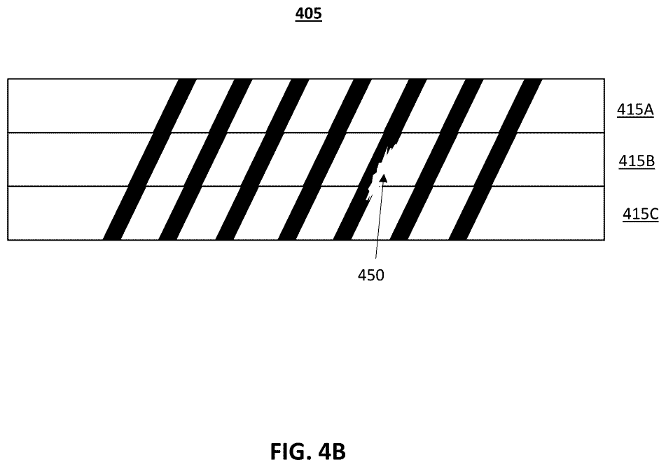

In some embodiments (e.g., embodiments where the testing and deploying module 160 deploys the anomaly detection DNN 130 to perform anomaly detection tasks), the testing and deploying module 160 may generate messages indicating presence or absence of anomaly based on outputs of the anomaly detection DNN 130 or anomaly scores. The testing and deploying module 160 may transmit the messages to external systems or devices, e.g., through the interface module 110. Certain aspects of the testing and deploying module 160 are described below in conjunction with FIGS. 3 and 4.

The compiler 170 compiles information of the anomaly detection DNN 130 to generate executable instructions that can be executed, e.g., by one or more hardware devices (e.g., processing units), to carry out neural network operations in the anomaly detection DNN 130. In some embodiments, the compiler 170 may generate a graph representing the anomaly detection DNN 130. The graph may include nodes and edges. A node may represent a specific neural network operation in the anomaly detection DNN 130. An edge may connect two nodes and represent a connection between the two corresponding neural network operations. In an example, an edge may encode a tensor that flows from one of the neural network operations to the other neural network operation. The tensor may be an output tensor of the first neural network operation and an input tensor of the second neural network operation. The edge may encode one or more attributes of the tensor, such as size, shape, storage format, and so on. The compiler 170 may use the graph to generate an executable version of the anomaly detection DNN 130. For instance, the compiler may generate computer program instructions for executing the anomaly detection DNN 130.

In some embodiments, the compiler 170 may generate configuration parameters that may be used to configure components of the hardware device(s) for executing the anomaly detection DNN 130. The configuration parameters may be stored in one or more configuration registers associated with the components of the hardware device(s). In some embodiments, the compiler 170 may compile the anomaly detection DNN 130 after the compressing module 140 compresses the anomaly detection DNN 130. For instance, the compiler 170 may generate configuration parameters that cause a hardware device to execute the anomaly detection DNN 130 to load activations and weights of a convolution into processing elements in a way that can acceleration computations in the processing elements based on sparsity in the activations or weights. The compiler 170 may further generate configuration parameters for configuring components of the hardware device(s) to perform computations accelerated based on sparsity.

The datastore 180 stores data received, generated, used, or otherwise associated with the anomaly detection system 100. For example, the datastore 180 stores the datasets used by the training module 120. The datastore 180 may also store data generated by the training module 120, such as the hyperparameters for training the anomaly detection DNN 130, internal parameters of the anomaly detection DNN 130 (e.g., weights, etc.), and so on. The datastore 180 may also store data generated by the compressing module 140, such as compressed weights, sparsity maps, and so on. The datastore 180 may also store data generated by the layer selecting module 150 and testing and deploying module 160. The datastore 180 may store instructions, configuration parameters, or other data generated by the compiler 170. The datastore 180 may include one or more memories. In the embodiment of FIG. 1, the datastore 180 is a component of the anomaly detection system 100. In other embodiments, the datastore 180 may be external to the anomaly detection system 100 and communicate with the anomaly detection system 100 through a network.

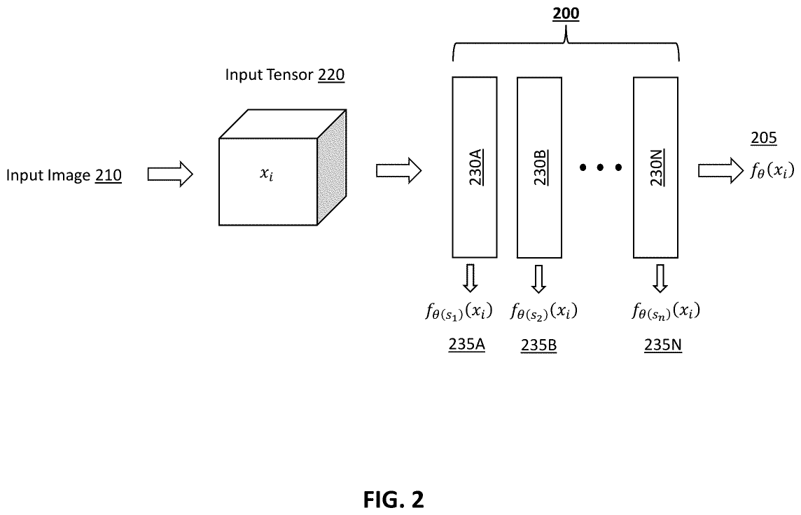

FIG. 2 illustrates an example DNN 200 for anomaly detection, in accordance with various embodiments. The DNN 200 may be an example of the anomaly detection DNN 130 in FIG. 1. As shown in FIG. 2, the DNN 200 includes convolutional blocks 230A-230N (collectively referred to as “convolutional blocks 230” or “convolutional block 230”). Each convolutional block 230 may include at least one convolutional layer. In other embodiments, the DNN 200 may include fewer, more, or different components. For example, the DNN 200 may have a fully-connected layer or SoftMax layer arranged after the convolutional blocks 230. As another example, the DNN 200 may have different numbers of convolutional blocks.

For the purpose of illustration, an input image 210 is used in the embodiments of FIG. 2. The input image 210 may be an image of an object, and the DNN 200 is used to detect whether the object has any anomaly. The input image 210 may be captured by one or more cameras. In some embodiments, the input image 210 may be generated from multiple images of the object. For instance, these images may be stitched together to form the input image 210. In some embodiments, the input image 210 may be obtained by the testing and deploying module 160 in FIG. 2.

The input image 210 is converted into an input tensor 220. As an example, the input tensor 220 in FIG. 2 is a 3D tensor that includes data elements (e.g., activations) arranged in a 3D structure. The input tensor 220 may be generated by encoding the input image 210. In some embodiments, the input tensor 220 may be generated by the testing and deploying module 160 in FIG. 2. The input tensor 220 is input into the DNN 200. The convolutional blocks 230 process the input tensor 220 and produce embedding features 235A-235N (collectively referred to as “convolutional blocks 230” or “convolutional block 230”). The embedding feature 235A is denoted as f_{θ(s}_{₁}₎(xᵢ), where s₁ denotes the spatial scale of the convolutional block 230A. The embedding feature 235B is denoted as f_{θ(s}_{₂}₎(xᵢ), where s₂ denotes the spatial scale of the convolutional block 230B. The embedding feature 235N is denoted as f_{θ(s}_{ₙ}₎(xᵢ, where sₙ denotes the spatial scale of the convolutional block 230N. Each embedding feature 235 may have the spatial scale of the convolutional block 230 that generates the embedding feature 235. In some embodiments, each embedding feature 235 may be a tensor, such as a 2D or 3D tensor.

The DNN 200 generates, using the input tensor 220, an output 205, which is denoted as f_{θ}(xᵢ) in FIG. 2. The output 205 and embedding features 235 extracted from the convolutional blocks 230 may be used to determine an anomaly score that can indicate whether the input image 210 shows any anomaly of the object. In some embodiments, not all the embedding features 235 are used for determining the anomaly score. For instance, one or more convolutional blocks 230 may be selected based on a spatial scale of the input image 210 or input tensor 220. The embedding feature(s) 235 extracted from the selected convolutional block(s) 235 may be used to determine the anomaly score, while the other embedding feature(s) 235 may not be used. In some embodiments, the convolutional blocks 230 may generate the embedding features 235 in parallel or even simultaneously.

FIG. 3 is a block diagram of a testing and deploying module 300, in accordance with various embodiments. The testing and deploying module 300 may be an example of the testing and deploying module 160 in FIG. 1. As shown in FIG. 3, the testing and deploying module 300 includes a data capturing assembly 310, an orientation module 320, a sensor controller 330, a deployment module 340, and a neural processing unit (NPU) 350. In other embodiments, alternative configurations, different or additional components may be included in the testing and deploying module 300. Further, functionality attributed to a component of the testing and deploying module 300 may be accomplished by a different component included in the testing and deploying module 300 or a different module or system.

The data capturing assembly 310 may facilitate capturing data of objects that can be used for detecting anomalies associated with the objects. In some embodiments, the data capturing assembly 310 may include one or more sensors that can detect objects placed inside or nearby the data capturing assembly 310. A sensor may capture at least part of an object and output sensor data. Examples of the sensor(s) may include image sensor, depth sensor, pressure sensor, ultrasound sensor, other types of sensors, or some combinations thereof. In an example, the data capturing assembly 310 may include one or more cameras that capture images of the object. Sensors in the data capturing assembly 310 may be placed at different locations. In some embodiments, different sensors may detect or capture an object from different angles. The data capturing assembly 310 may also include one or more other components in addition to the sensor(s). For instance, the data capturing assembly 310 may include a component for fixing a sensor or an object. The component may be movable for changing the orientation (e.g., position or direction) of the sensor or object. Certain aspects of the data capturing assembly 310 are provided below in conjunction with FIG. 4A.

The orientation module 320 may control the orientation (e.g., position or direction) of one or more components of the data capturing assembly 310 or objects placed inside the data capturing assembly 310. In some embodiments, the orientation module 320 may detect the starting orientation of a component (e.g., a sensor) of the data capturing assembly 310 or an object inside the data capturing assembly 310. The orientation module 320 may also determine a target orientation of the sensor or object and determine whether the current orientation of the sensor or object matches (e.g., is the same as or is substantially similar to) the target orientation. In response to determining that the starting orientation does not match the target orientation, the orientation module 320 may move the sensor or object to the target orientation. Additionally or alternatively, the orientation module 320 may move the sensor or object from a target orientation to another target orientation, for instance, for capturing different features of the object. After the sensor or object reaches the target orientation, the orientation module 320 may notify the sensor controller 330 so that the sensor controller 330 may control the sensor to start scanning the object.

The sensor controller 330 controls the sensor(s) in the data capturing assembly 310. For instance, the sensor controller 330 may configure one or more setting of a sensor so that the sensor will capture sensor data of an object in accordance with the one or more settings. Examples of the settings may include scanning speed, scanning time, scanning resolution, and so on. In some embodiments, the sensor controller 330 may configure different settings for different sensors for the same object. The settings of the sensor may impact the datum to be input into a DNN (e.g., the anomaly detection DNN 130) for detecting anomaly. For instance, the sensor controller 330 may configure a camera to produce images having a particular resolution. In some embodiments, the sensor controller 330 may determine settings of a sensor based on a user input. The user input may include information of a task of detecting anomaly of an object. The information of the task may include information about the object, information about possible anomaly, information about the DNN performing the task, information about the hardware device (e.g., the NPU 350) executing the DNN, and so on.

The deployment module 340 may deploy DNNs for performing anomaly detection tasks. Examples of the DNNs include the anomaly detection DNN 130 in FIG. 1 and the DNN 200 in FIG. 2. In some embodiments, the deployment module 340 may generate an input to a DNN. The input may be a datum that the deployment module 340 generates from sensor data captured by sensor(s) in the data capturing assembly 310. In an example, the deployment module 340 may receive one or more images of the object from the data capturing assembly 310. The deployment module 340 may generate an input datum from the one or more images. In embodiments where there are multiple images of the object, the deployment module 340 may combine the images into an aggregated image, e.g., by stitching the images together. A portion of an image may be removed for being stitched with one or more other images. The deployment module 340 may generate an input tensor from an image, either an image from the data capturing assembly 310 or an aggregated image. An example of the input tensor may be the input tensor 220 in FIG. 2.

The deployment module 340 may provide the input datum into the NPU 350. The NPU 350 may execute DNNs, including DNNs for anomaly detection. For instance, the NPU 350 can execute a DNN by carrying out neural network operations in the DNN. The process of carrying out a neural network operation is also referred to as a process of executing the neural network operation or performing the neural network operation. The execution of the DNN may be for training the DNN or for using the DNN to perform AI tasks. The NPU 350 may be a DNN accelerator. In some embodiments, the NPU 350 includes a memory, one or more data processing units, and a direct memory access engine that may transfer data between the memory and the one or more data processing units. A data processing unit may include processing elements, which may be arranged in an array. A processing element may include one or more multiplier and one or more adders. The processing elements can perform multiply-accumulate (MAC) operations. The data processing unit may also include acceleration logic, which may acceleration neural network operations based on data sparsity. For instance, the acceleration logic can acceleration convolutions based on sparsity in input activation tensors or weight tensors. In some embodiments, the NPU 350 may operate in accordance with instructions (e.g., configuration parameters) provided by a compiler, such as the compiler 170 in FIG. 1.

The input datum from the deployment module 340 may be written into the memory of the NPU 350, then transferred to one or more data processing units by the direct memory access engine. The NPU 350 may run an inference process of the DNN for detecting anomaly in the input datum. During the inference process, the one or more data processing units may execute neural network operations (e.g., convolutions, etc.) in the DNN with the input datum or new data generated from the input datums. Even though not shown in FIG. 2, a DNN for anomaly detection may be executed by one or more central processing units, graphics processing units, or other types of processing units in addition to or alternative to the NPU 350.

The deployment module 340 may obtain the output of the DNN and outputs of the convolutional blocks from the NPU 350. The deployment module 340 may determine an anomaly score from the output of the DNN and outputs of the convolutional blocks, as described above. The deployment module 340 may generate a message indicating the result of the anomaly detection. For instance, the message may indicate presence or absence of anomaly in the object. The message may be sent to a device or system to facilitate the device or system (or a user of the device or system) processing the object. In an example in which anomaly is not detected, the object may be considered as expected, desired, standard, or usual and may be used for manufacturing, providing service, sale, etc. In another example in which anomaly is detected, the object may be discarded or fixed before it can be used.

FIG. 4A illustrates a data capturing assembly 400, in accordance with various embodiments. The data capturing data capturing assembly 400 may be an example of the data capturing assembly 310 in FIG. 3. As shown in FIG. 4A, the data capturing assembly 400 includes a housing 410, cameras 420A-420C, and a station 430. In other embodiments, the data capturing assembly 400 may include fewer, more, or different components.

The housing 410 provides an enclosure for the cameras 420A-420B and station 430. The cameras 420A-420C may be fixed on the housing 410. For the purpose of illustration, the cameras 420A-420B are arranged on the top of the housing 410. In other embodiments, the cameras 420A-420B may be at other locations inside the housing 410. The cameras 420A-420B are configured to capture photos of objects placed on the station 430 for detecting anomaly in the objects. For the purpose of illustration, a screw 440 with an anomaly 450 is placed on the station 430. The cameras 420A-420B may capture images of the screw 440 from different angles. In some embodiments, the station 430 can facilitate rotation of the screw 440 so that at least one of the cameras 420A-420B may capture 360-degree images of the screw 440. Even though FIG. 4A shows three cameras, the data capturing assembly 400 may include a different number of cameras in other embodiments. Also, the orientation of a camera may be different. Alternatively or additionally, the data capturing assembly 400 may include other types of sensors.

FIG. 4B shows an aggregated image 405, in accordance with various embodiments. The aggregated image 405 may be generated from images 415A-415C, which are images of the screw 440 that are captured by the cameras 420A-420C. The aggregated image 405 may be generated by stitching the images 415A-415C together, e.g., by aligning threads on the screw 440. The aggregated image 405 shows the anomaly 450. In some embodiments, the anomaly 450 may be automatically detected by inputting the aggregated image 405 into a DNN, e.g., the anomaly detection DNN 130 in FIG. 1. In some embodiments, the aggregated image 405 may be converted to a tensor (e.g., the tensor 220 in FIG. 2), and the tensor is input into the DNN. The anomaly 450 may be detected based on the output of the DNN and outputs of convolutional blocks in the DNN. In some embodiments, the convolutional blocks in the DNN may be selected from a pool of convolutional blocks. The convolutional blocks may be selected based on the resolution of the aggregated image 405 or one or more of the images 415A-415C. The selection may also be based on spatial scales of the convolutional blocks.

The images 415A-415C shown in FIG. 4B are used for the purpose of illustration and simplicity. Certain features of the screw 440 or the data capturing assembly 400 may not be shown in the images 415A-415C. Also, a different number of images may be used to generate the aggregated image 405.

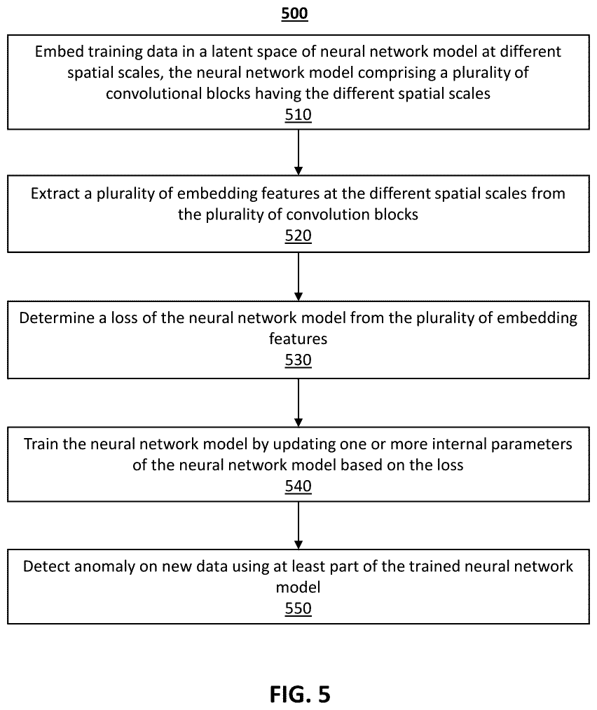

FIG. 5 is a flowchart of a method 500 of anomaly detection, in accordance with various embodiments. The method 500 may be performed by the anomaly detection system 100 in FIG. 1. Although the method 500 is described with reference to the flowchart illustrated in FIG. 5, many other methods for anomaly detection may alternatively be used. For example, the order of execution of the steps in FIG. 5 may be changed. As another example, some of the steps may be changed, eliminated, or combined.

The anomaly detection system 100 embeds 510 training data in a latent space of a DNN model at different spatial scales. The training data includes normal data lacking an anomaly. The DNN model comprises a plurality of convolutional blocks having the different spatial scales. In some embodiments, an example of the DNN model is the anomaly detection DNN 130 in FIG. 1 or DNN 200 in FIG. 2. In some embodiments, a spatial scale indicates a model embedding extracted at a convolutional block of the neural network model. The convolutional block comprises one or more convolutional layers. In some embodiments, a spatial scale may indicate a resolution of the corresponding convolutional block.

In some embodiments, the anomaly detection system 100 embeds the normal data in a latent space of the DNN model at the different spatial scales concurrently. In some embodiments, the training data comprises a normal datum lacking an anomaly and an anomalous datum having the anomaly. The normal datum and the anomalous datum have different class labels.

The anomaly detection system 100 extracts 520 a plurality of embedding features from the plurality of convolutional blocks. In some embodiments, the plurality of embedding features is generated by the plurality of convolutional blocks using the training data. The plurality of embedding features is at the different spatial scales. In some embodiments, an embedding feature is at the spatial scale of the convolutional block that generates the embedding feature.

The anomaly detection system 100 determines 530 a loss of the DNN model from the plurality of embedding feature. In some embodiments, for each embedding feature, the anomaly detection system 100 determines a distance between the embedding feature and a mean of the different spatial scales. The anomaly detection system 100 accumulates distances for the plurality of embedding features. In some embodiments, the distance between an embedding feature and the mean of the different spatial scales is a Euclidean distance.

The anomaly detection system 100 trains 540 the DNN model by updating one or more internal parameters of the DNN model based on the loss. In some embodiments, the anomaly detection system 100 updates the one or more internal parameters of the DNN model to minimize the loss. In some embodiments, the one or more internal parameters of the DNN model include one or more weights in a convolutional layer of the DNN model.

The anomaly detection system 100 detects 550 anomaly on new data using at least part of the trained DNN model. The new data comprises an anomalous datum having the anomaly. In some embodiments, the anomaly detection system 100 selects one or more convolutional blocks from the plurality of convolutional blocks. The one or more convolutional blocks are used to detect anomaly on the new data. In some embodiments, the new data comprises an image. The one or more convolutional blocks are selected based on one or more spatial scales of the one or more convolutional blocks and a spatial scale of the image. In some embodiments, the anomaly detection system 100 also validates effectiveness of the neural network model after the training by using the neural network model after the training to perform anomaly detection on testing data having verified anomaly.

In some embodiments, the anomaly detection system 100 inputs the new data into at least part of the trained DNN model. The anomaly detection system 100 determines an anomaly score from an output of at least part of the trained DNN model. The anomaly detection system 100 determines whether the new data has anomaly based on the anomaly score. In some embodiments, the anomaly detection system 100 extracts one or more new embedding features from one or more convolutional blocks in at least part of the neural network model. The anomaly detection system 100 determines the anomaly score from the one or more new embedding features. In some embodiments, the anomaly detection system 100 compares the anomaly score with a threshold score and determines that the new data has anomaly in response to determining that the anomaly score is greater than the threshold score.

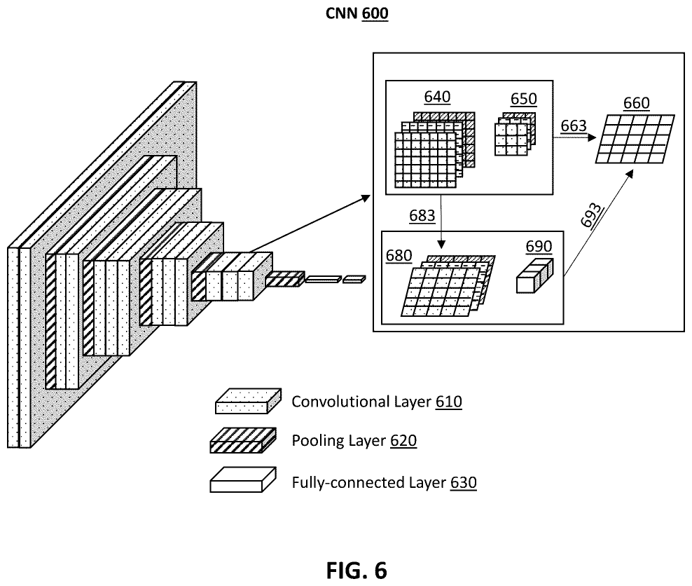

FIG. 6 illustrates a CNN 600, in accordance with various embodiments. The CNN 600 may be at least part of a DNN that can be used for anomaly detection, such as the anomaly detection DNN 130 in FIG. 1 or DNN 200 in FIG. 2. For the purpose of illustration, the CNN 600 includes a sequence of layers comprising a plurality of convolutional layers 610 (individually referred to as “convolutional layer 610”), a plurality of pooling layers 620 (individually referred to as “pooling layer 620”), and a plurality of fully-connected layers 630 (individually referred to as “fully-connected layer 630”). In other embodiments, the CNN 600 may include fewer, more, or different layers. In an execution of the CNN 600, the layers of the CNN 600 execute tensor computation that includes many tensor operations, such as convolutions, interpolations, pooling operations, elementwise operations (e.g., elementwise addition, elementwise multiplication, etc.), other types of tensor operations, or some combination thereof.

The convolutional layers 610 summarize the presence of features in inputs to the CNN 600. The convolutional layers 610 function as feature extractors. The first layer of the CNN 600 is a convolutional layer 610. In an example, a convolutional layer 610 performs a convolution on an input tensor 640 (also referred to as IFM 640) and a filter 650. As shown in FIG. 6, the IFM 640 is represented by a 7×7×3 three-dimensional (3D) matrix. The IFM 640 includes 3 input channels, each of which is represented by a 7×7 two-dimensional (2D) matrix. The 7×7 2D matrix includes 7 input elements (also referred to as input points) in each row and 7 input elements in each column. The filter 650 is represented by a 3×3×3 3D matrix. The filter 650 includes 3 kernels, each of which may correspond to a different input channel of the IFM 640. A kernel is a 2D matrix of weights, where the weights are arranged in columns and rows. A kernel can be smaller than the IFM. In the embodiments of FIG. 6, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 650 in extracting features from the IFM 640.

The convolution includes MAC operations with the input elements in the IFM 640 and the weights in the filter 650. The convolution may be a standard convolution 663 or a depthwise convolution 683. In the standard convolution 663, the whole filter 650 slides across the IFM 640. All the input channels are combined to produce an output tensor 660 (also referred to as output feature map (OFM) 660). The OFM 660 is represented by a 5×5 2D matrix. The 5×5 2D matrix includes 5 output elements (also referred to as output points) in each row and 5 output elements in each column. For the purpose of illustration, the standard convolution includes one filter in the embodiments of FIG. 6. In embodiments where there are multiple filters, the standard convolution may produce multiple output channels (OCs) in the OFM 660.

The multiplication applied between a kernel-sized patch of the IFM 640 and a kernel may be a dot product. A dot product is the elementwise multiplication between the kernel-sized patch of the IFM 640 and the corresponding kernel, which is then summed, always resulting in a single value. Because it results in a single value, the operation is often referred to as the “scalar product.” Using a kernel smaller than the IFM 640 is intentional as it allows the same kernel (set of weights) to be multiplied by the IFM 640 multiple times at different points on the IFM 640. Specifically, the kernel is applied systematically to each overlapping part or kernel-sized patch of the IFM 640, left to right, top to bottom. The result from multiplying the kernel with the IFM 640 one time is a single value. As the kernel is applied multiple times to the IFM 640, the multiplication result is a 2D matrix of output elements. As such, the 2D output matrix (i.e., the OFM 660) from the standard convolution 663 is referred to as an OFM.

In the depthwise convolution 683, the input channels are not combined. Rather, MAC operations are performed on an individual input channel and an individual kernel and produce an OC. As shown in FIG. 6, the depthwise convolution 683 produces a depthwise output tensor 680. The depthwise output tensor 680 is represented by a 5×5×3 3D matrix. The depthwise output tensor 680 includes 3 OCs, each of which is represented by a 5×5 2D matrix. The 5×5 2D matrix includes 5 output elements in each row and 5 output elements in each column. Each OC is a result of MAC operations of an input channel of the IFM 640 and a kernel of the filter 650. For instance, the first OC (patterned with dots) is a result of MAC operations of the first input channel (patterned with dots) and the first kernel (patterned with dots), the second OC (patterned with horizontal strips) is a result of MAC operations of the second input channel (patterned with horizontal strips) and the second kernel (patterned with horizontal strips), and the third OC (patterned with diagonal stripes) is a result of MAC operations of the third input channel (patterned with diagonal stripes) and the third kernel (patterned with diagonal stripes). In such a depthwise convolution, the number of input channels equals the number of OCs, and each OC corresponds to a different input channel. The input channels and output channels are referred to collectively as depthwise channels. After the depthwise convolution, a pointwise convolution 693 is then performed on the depthwise output tensor 680 and a 1×1×3 tensor 690 to produce the OFM 660. The tensor 690 is a 1D tensor.

The OFM 660 is then passed to the next layer in the sequence. In some embodiments, the OFM 660 is passed through an activation function. An example activation function is ReLU. ReLU is a calculation that returns the value provided as input directly, or the value zero if the input is zero or less. The convolutional layer 610 may receive several images as input and calculate the convolution of each of them with each of the kernels. This process can be repeated several times. For instance, the OFM 660 is passed to the subsequent convolutional layer 610 (i.e., the convolutional layer 610 following the convolutional layer 610 generating the OFM 660 in the sequence). The subsequent convolutional layers 610 perform a convolution on the OFM 660 with new kernels and generate a new feature map. The new feature map may also be normalized and resized. The new feature map can be kernelled again by a further subsequent convolutional layer 610, and so on.

In some embodiments, a convolutional layer 610 has four hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 610). The convolutional layers 610 may perform various types of convolutions, such as 2D convolution, dilated or atrous convolution, spatial separable convolution, depthwise separable convolution, transposed convolution, and so on. The CNN 600 includes 66 convolutional layers 610. In other embodiments, the CNN 600 may include a different number of convolutional layers.

The pooling layers 620 down-sample feature maps generated by the convolutional layers, e.g., by summarizing the presence of features in the patches of the feature maps. A pooling layer 620 is placed between two convolutional layers 610: a preceding convolutional layer 610 (the convolutional layer 610 preceding the pooling layer 620 in the sequence of layers) and a subsequent convolutional layer 610 (the convolutional layer 610 subsequent to the pooling layer 620 in the sequence of layers). In some embodiments, a pooling layer 620 is added after a convolutional layer 610, e.g., after an activation function (e.g., ReLU, etc.) has been applied to the OFM 660.

A pooling layer 620 receives feature maps generated by the preceding convolutional layer 610 and applies a pooling operation to the feature maps. The pooling operation reduces the size of the feature maps while preserving their important characteristics. Accordingly, the pooling operation improves the efficiency of the DNN and avoids over-learning. The pooling layers 620 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 620 applied to a feature map of 6×6 results in an output pooled feature map of 3×3. The output of the pooling layer 620 is input into the subsequent convolutional layer 610 for further feature extraction. In some embodiments, the pooling layer 620 operates upon each feature map separately to create a new set of the same number of pooled feature maps.

The fully-connected layers 630 are the last layers of the DNN. The fully-connected layers 630 may be convolutional or not. The fully-connected layers 630 receive an input operand. The input operand defines the output of the convolutional layers 610 and pooling layers 620 and includes the values of the last feature map generated by the last pooling layer 620 in the sequence. The fully-connected layers 630 apply a linear combination and an activation function to the input operand and generate a vector. The vector may contain as many elements as there are classes: element i represents the probability that the image belongs to class i. Each element is therefore between 0 and 1, and the sum of all may be one. These probabilities are calculated by the last fully-connected layer 630 by using a logistic function (binary classification) or a SoftMax function (multi-class classification) as an activation function. In some embodiments, the fully-connected layers 630 multiply each input element by weight, make the sum, and then apply an activation function (e.g., logistic if N=2, SoftMax if N>2). This is equivalent to multiplying the input operand by the matrix containing the weights.

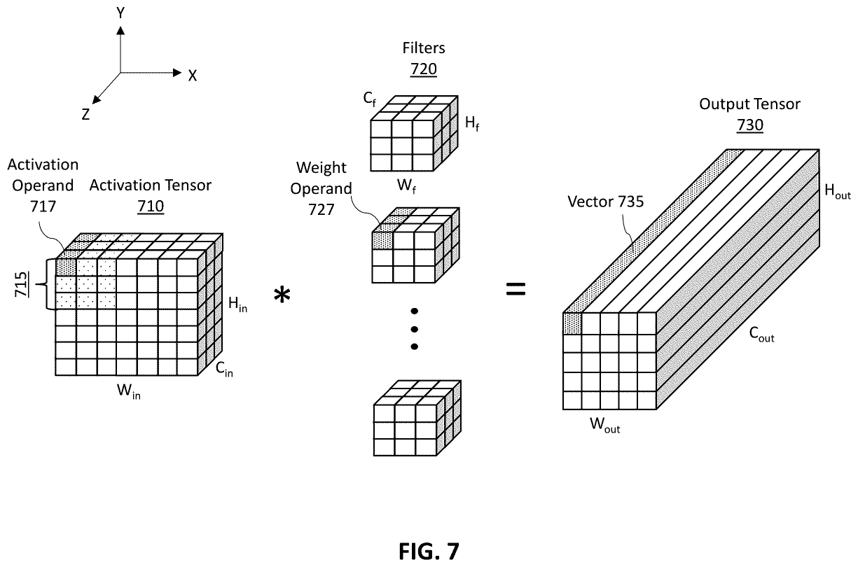

FIG. 7 illustrates an example convolution, in accordance with various embodiments. The convolution may be a deep learning operation in a convolutional layer of a DNN, e.g., a convolutional layer 610 in FIG. 6. The convolution can be executed on an activation tensor 710 and filters 720 (individually referred to as “filter 720”). The filters may constitute a weight tensor of the convolution. The result of the convolution is an output tensor 730.

The activation tensor 710 may be computed in a previous layer of the DNN. In some embodiments (e.g., embodiments where the convolutional layer is the first layer of the DNN), the activation tensor 710 may be an image. In the embodiments of FIG. 7, the activation tensor 710 includes activations (also referred to as “input activations,” “elements,” or “input elements”) arranged in a 3D matrix. The activation tensor 710 may also be referred to as an input tensor of the convolution. An input element is a data point in the activation tensor 710. The activation tensor 710 has a spatial size Hᵢₙ×Wᵢₙ×Cᵢₙ, where Hᵢₙ is the height of the 3D matrix (i.e., the length along the Y axis, which indicates the number of activations in a column in the 3D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For the purpose of simplicity and illustration, the activation tensor 710 has a spatial size of 7×7×3, i.e., the activation tensor 710 includes three input channels and each input channel has a 7×7 2D matrix. Each input element in the activation tensor 710 may be represented by a (X, Y, Z) coordinate. In other embodiments, the height, width, or depth of the activation tensor 710 may be different.

Each filter 720 includes weights arranged in a 3D matrix. The values of the weights may be determined through training the DNN. A filter 720 has a spatial size H_{f}×W_{f}×C_{f}, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and C_{f} is the depth of the filter (i.e., the length along the Z axis, which indicates the number of channels). In some embodiments, C_{f} equals Cᵢₙ. For purpose of simplicity and illustration, each filter 720 in FIG. 7 has a spatial size of 3×3×3, i.e., the filter 720 includes 7 convolutional kernels with a spatial size of 3×3. In other embodiments, the height, width, or depth of the filter 720 may be different. The spatial size of the convolutional kernels is smaller than the spatial size of the 2D matrix of each input channel in the activation tensor 710.

An activation or weight may take one or more bytes in a memory. The number of bytes for an activation or weight may depend on the data format. For example, when the activation or weight has an INT8 format, the activation takes one byte. When the activation or weight has a FP16 format, the activation or weight takes two bytes. Other data formats may be used for activations or weights.

In the convolution, each filter 720 slides across the activation tensor 710 and generates a 2D matrix for an output channel in the output tensor 730. In the embodiments of FIG. 7, the 2D matrix has a spatial size of 5×5. The output tensor 730 includes activations (also referred to as “output activations,” “elements,” or “output element”) arranged in a 3D matrix. An output activation is a data point in the output tensor 730. The output tensor 730 has a spatial size Hₒᵤₜ×Wₒᵤₜ×Cₒᵤₜ, where Hₒᵤₜ is the height of the 3D matrix (i.e., the length along the Y axis, which indicates the number of output activations in a column in the 2D matrix of each output channel), Wₒᵤₜ is the width of the 3D matrix (i.e., the length along the X axis, which indicates the number of output activations in a row in the 2D matrix of each output channel), and Cₒᵤₜ is the depth of the 3D matrix (i.e., the length along the Z axis, which indicates the number of output channels). Cₒᵤₜ may equal the number of filters 720 in the convolution. Hₒᵤₜ and Wₒᵤₜ may depend on the heights and weights of the activation tensor 710 and each filter 720. In an example where the kernel size is 1×1, Hₒᵤₜ and Wₒᵤₜ may equal to Hᵢₙ and Wᵢₙ, respectively.

As a part of the convolution, MAC operations can be performed on a 3×3×3 subtensor 715 (which is highlighted with a dotted pattern in FIG. 7) in the activation tensor 710 and each filter 720. The result of the MAC operations on the subtensor 715 and one filter 720 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 715 and all the filters 720 are finished, a vector 735 is produced. The vector 735 is highlighted with a dotted pattern in FIG. 7. The vector 735 includes a sequence of output activations, which are arranged along the Z axis. The output activations in the vector 735 have the same (x, y) coordinate, but the output activations correspond to different output channels and have different Z coordinates. The dimension of the vector 735 along the Z axis may equal the total number of output channels in the output tensor 730. After the vector 735 is produced, further MAC operations are performed to produce additional vectors till the output tensor 730 is produced. In the embodiments of FIG. 7, the output tensor 730 is computed in a Z-major format. When the output tensor 730 is computed in the ZXY format, the vector that is adjacent to the vector 735 along the X axis may be computed right after the vector 735. When the output tensor 730 is computed in the ZYX format, the vector that is adjacent to the vector 735 along the Y axis may be computed right after the vector 735. The output tensor 730 may be permuted and stored in a memory in an X-major format or Y-major format.

In some embodiments, the MAC operations on a 3×3×3 subtensor (e.g., the subtensor 715) and a filter 720 may be performed by a plurality of MAC units. One or more MAC units may receive an input operand (e.g., an activation operand 717 shown in FIG. 7) and a weight operand (e.g., the weight operand 727 shown in FIG. 7). The activation operand 717 includes a sequence of activations having the same (x, y) coordinate but different z coordinates. The activation operand 717 includes an activation from each of the input channels in the activation tensor 710. The weight operand 727 includes a sequence of weights having the same (x, y) coordinate but different z coordinates. The weight operand 727 includes a weight from each of the channels in the filter 720. Activations in the activation operand 717 and weights in the weight operand 727 may be sequentially fed into a MAC unit. The MAC unit may receive an activation and a weight (“an activation-weight pair”) at a time and multiple the activation and the weight. The position of the activation in the activation operand 717 may match the position of the weight in the weight operand 727. The activation and weight may correspond to the same channel.

Activations or weights may be floating-point numbers. Floating-point numbers may have various data formats, such as FP32, FP16, BF16, and so on. A floating-point number may be a positive or negative number with a decimal point. A floating-point number may be represented by a sequence of bits that includes one or more bits representing the sign of the floating-point number (e.g., positive or negative), bits representing an exponent of the floating-point number, and bits representing a mantissa of the floating-point number. The mantissa is the part of a floating-point number that represents the significant digits of that number. The mantissa is multiplied by the base raised to the exponent to give the actual value of the floating-point number.

In some embodiments, the output activations in the output tensor 730 may be further processed based on one or more activation functions before they are written into the memory or input into the next layer of the DNN. The processing based on the one or more activation functions may be at least part of the post processing of the convolution. In some embodiments, the post processing may include one or more other computations, such as offset computation, bias computation, and so on. The results of the post processing may be stored in a local memory of the compute block and be used as input to the next DNN layer. In some embodiments, the input activations in the activation tensor 710 may be results of post processing of the previous DNN layer.

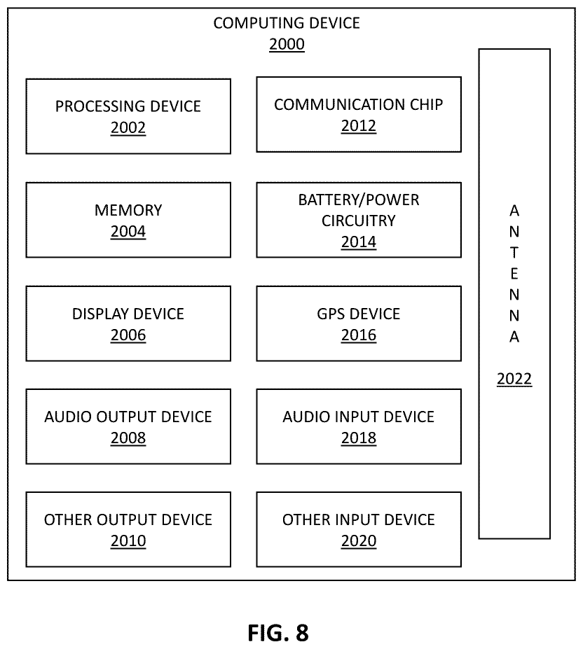

FIG. 8 is a block diagram of an example computing device 2000, in accordance with various embodiments. In some embodiments, the computing device 2000 can be used as at least part of the anomaly detection system 100. A number of components are illustrated in FIG. 8 as included in the computing device 2000, but any one or more of these components may be omitted or duplicated, as suitable for the application. In some embodiments, some or all of the components included in the computing device 2000 may be attached to one or more motherboards. In some embodiments, some or all of these components are fabricated onto a single system on a chip (SoC) die. Additionally, in various embodiments, the computing device 2000 may not include one or more of the components illustrated in FIG. 8, but the computing device 2000 may include interface circuitry for coupling to the one or more components. For example, the computing device 2000 may not include a display device 2006, but may include display device interface circuitry (e.g., a connector and driver circuitry) to which a display device 2006 may be coupled. In another set of examples, the computing device 2000 may not include an audio input device 2018 or an audio output device 2008 but may include audio input or output device interface circuitry to which an audio input device 2018 or audio output device 2008 may be coupled.

The computing device 2000 may include a processing device 2002 (e.g., one or more processing devices). The processing device 2002 processes electronic data from registers and/or memory to transform that electronic data into other electronic data that may be stored in registers and/or memory. The computing device 2000 may include a memory 2004, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 2004 may include memory that shares a die with the processing device 2002. In some embodiments, the memory 2004 includes one or more non-transitory computer-readable media storing instructions executable to perform operations for anomaly detection (e.g., the method 500 described in conjunction with FIG. 5) or some operations performed by one or more components of the anomaly detection system 100. The instructions stored in the one or more non-transitory computer-readable media may be executed by the processing device 2002.

In some embodiments, the computing device 2000 may include a communication chip 2012 (e.g., one or more communication chips). For example, the communication chip 2012 may be configured for managing wireless communications for the transfer of data to and from the computing device 2000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 2012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2012 may operate in accordance with other wireless protocols in other embodiments. The computing device 2000 may include an antenna 2022 to facilitate wireless communications and/or to receive other wireless communications (such as AM or FM radio transmissions).

In some embodiments, the communication chip 2012 may manage wired communications, such as electrical, optical, or any other suitable communication protocols (e.g., the Ethernet). As noted above, the communication chip 2012 may include multiple communication chips. For instance, a first communication chip 2012 may be dedicated to shorter-range wireless communications such as Wi-Fi or Bluetooth, and a second communication chip 2012 may be dedicated to longer-range wireless communications such as global positioning system (GPS), EDGE, GPRS, CDMA, WiMAX, LTE, EV-DO, or others. In some embodiments, a first communication chip 2012 may be dedicated to wireless communications, and a second communication chip 2012 may be dedicated to wired communications.

The computing device 2000 may include battery/power circuitry 2014. The battery/power circuitry 2014 may include one or more energy storage devices (e.g., batteries or capacitors) and/or circuitry for coupling components of the computing device 2000 to an energy source separate from the computing device 2000 (e.g., AC line power).

The computing device 2000 may include a display device 2006 (or corresponding interface circuitry, as discussed above). The display device 2006 may include any visual indicators, such as a heads-up display, a computer monitor, a projector, a touchscreen display, a liquid crystal display (LCD), a light-emitting diode display, or a flat panel display, for example.

The computing device 2000 may include an audio output device 2008 (or corresponding interface circuitry, as discussed above). The audio output device 2008 may include any device that generates an audible indicator, such as speakers, headsets, or earbuds, for example.

The computing device 2000 may include an audio input device 2018 (or corresponding interface circuitry, as discussed above). The audio input device 2018 may include any device that generates a signal representative of a sound, such as microphones, microphone arrays, or digital instruments (e.g., instruments having a musical instrument digital interface (MIDI) output).

The computing device 2000 may include a GPS device 2016 (or corresponding interface circuitry, as discussed above). The GPS device 2016 may be in communication with a satellite-based system and may receive a location of the computing device 2000, as known in the art.

The computing device 2000 may include another output device 2010 (or corresponding interface circuitry, as discussed above). Examples of the other output device 2010 may include an audio codec, a video codec, a printer, a wired or wireless transmitter for providing information to other devices, or an additional storage device.

The computing device 2000 may include another input device 2020 (or corresponding interface circuitry, as discussed above). Examples of the other input device 2020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2000 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 2000 may be any other electronic device that processes data.

The following paragraphs provide various examples of the embodiments disclosed herein.

Example 1 provides a method for anomaly detection, the method including embedding training data in a latent space of a neural network model at different spatial scales, the neural network model comprising a plurality of convolutional blocks having the different spatial scales; extracting a plurality of embedding features at the different spatial scales from the plurality of convolutional blocks; determining a loss of the neural network model from the plurality of embedding features; training the neural network model by updating one or more internal parameters of the neural network model based on the loss; and detecting anomaly on new data using at least part of the trained neural network model, in which the training data comprises a normal datum lacking an anomaly, and the new data comprises an anomalous datum having the anomaly.

Example 2 provides the method of example 1, in which a spatial scale indicates a model embedding extracted at a convolutional block of the neural network model, wherein the convolutional block comprises one or more convolutional layers.

Example 3 provides the method of example 1 or 2, in which the training data further comprises an anomalous datum having the anomaly, wherein the normal datum and the anomalous datum have different class labels.

Example 4 provides the method of any one of examples 1-3, in which determining the loss of the DNN model includes for each embedding feature, determining a distance between the embedding feature and a mean of the different spatial scales; and accumulating distances for the plurality of embedding features.

Example 5 provides the method of example 4, in which the distance is a Euclidean distance.

Example 6 provides the method of any one of examples 1-5, further including selecting one or more convolutional blocks from the plurality of convolutional blocks, in which the one or more convolutional blocks are used to detect anomaly on the new data.

Example 7 provides the method of example 6, in which the new data includes an image, in which the one or more convolutional blocks are selected based on one or more spatial scales of the one or more convolutional blocks and a spatial scale of the image.

Example 8 provides the method of any one of examples 1-7, in which detecting anomaly on the new data includes inputting the new data into at least part of the DNN model after the training; determining an anomaly score from an output of at least part of the DNN model; and determining whether the new data has anomaly based on the anomaly score.

Example 9 provides the method of example 8, in which determining the anomaly score includes extracting one or more new embedding features from one or more convolutional blocks in at least part of the neural network model; and determining the anomaly score from the one or more new embedding features.

Example 10 provides the method of any one of examples 1-9, further including validating effectiveness of the neural network model after the training by using the neural network model after the training to perform anomaly detection on testing data having verified anomaly.

Example 11 provides one or more non-transitory computer-readable media storing instructions executable to perform operations for anomaly detection, the operations including embedding training data in a latent space of a neural network model at different spatial scales, the neural network model comprising a plurality of convolutional blocks having the different spatial scales; extracting a plurality of embedding features at the different spatial scales from the plurality of convolutional blocks; determining a loss of the neural network model from the plurality of embedding features; training the neural network model by updating one or more internal parameters of the neural network model based on the loss; and detecting anomaly on new data using at least part of the trained neural network model, in which the training data comprises a normal datum lacking an anomaly, and the new data comprises an anomalous datum having the anomaly.

Example 12 provides the one or more non-transitory computer-readable media of example 11, in which a spatial scale indicates a model embedding extracted at a convolutional block of the neural network model, wherein the convolutional block comprises one or more convolutional layers.

Example 13 provides the one or more non-transitory computer-readable media of example 11 or 12, in which the training data further comprises an anomalous datum having the anomaly, wherein the normal datum and the anomalous datum have different class labels.

Example 14 provides the one or more non-transitory computer-readable media of any one of examples 11-13, in which determining the loss of the DNN model includes for each embedding feature, determining a distance between the embedding feature and a mean of the different spatial scales; and accumulating distances for the plurality of embedding features.

Example 15 provides the one or more non-transitory computer-readable media of example 14, in which the distance is a Euclidean distance.

Example 16 provides the one or more non-transitory computer-readable media of any one of examples 11-15, in which the operations further include selecting one or more convolutional blocks from the plurality of convolutional blocks based on one or more spatial scales of the one or more convolutional blocks and a spatial scale of the new data, in which the one or more convolutional blocks are used to detect anomaly on the new data.

Example 17 provides the one or more non-transitory computer-readable media of any one of examples 11-16, in which detecting anomaly on the new data includes inputting the new data into at least part of the DNN model after the training; determining an anomaly score from an output of at least part of the DNN model; and determining whether the new data has anomaly based on the anomaly score.

Example 18 provides an apparatus for anomaly detection, the apparatus including a computer processor for executing computer program instructions; and a non-transitory computer-readable memory storing computer program instructions executable by the computer processor to perform operations including embedding training data in a latent space of a neural network model at different spatial scales, the neural network model comprising a plurality of convolutional blocks having the different spatial scales, extracting a plurality of embedding features at the different spatial scales from the plurality of convolutional blocks, determining a loss of the neural network model from the plurality of embedding features, training the neural network model by updating one or more internal parameters of the neural network model based on the loss, and detecting anomaly on new data using at least part of the trained neural network model, in which the training data comprises a normal datum lacking an anomaly, and the new data comprises an anomalous datum having the anomaly.

Example 19 provides the apparatus of example 18, in which a spatial scale indicates a model embedding extracted at a convolutional block of the neural network model, wherein the convolutional block comprises one or more convolutional layers.

Example 20 provides the apparatus of example 18 or 19, in which the operations further include selecting one or more convolutional blocks from the plurality of convolutional blocks based on one or more spatial scales of the one or more convolutional blocks and a spatial scale of the new data, in which the one or more convolutional blocks are used to detect anomaly on the new data.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method for anomaly detection, the method comprising:
embedding training data in a latent space of a neural network model at different spatial scales, the neural network model comprising a plurality of convolutional blocks having the different spatial scales;
extracting a plurality of embedding features at the different spatial scales from the plurality of convolutional blocks;
determining a loss of the neural network model from the plurality of embedding features;
training the neural network model by updating one or more internal parameters of the neural network model based on the loss; and
detecting anomaly on new data using at least part of the trained neural network model,
wherein the training data comprises a normal datum lacking an anomaly, and the new data comprises an anomalous datum having the anomaly.

2. The method of claim 1, wherein a spatial scale indicates a model embedding extracted at a convolutional block of the neural network model, wherein the convolutional block comprises one or more convolutional layers.

3. The method of claim 1, wherein the training data further comprises an anomalous datum having the anomaly, wherein the normal datum and the anomalous datum in the training data have different class labels.

4. The method of claim 1, wherein determining the loss of the neural network model comprises:
for each embedding feature, determining a distance between the embedding feature and a mean of the different spatial scales; and
accumulating distances for the plurality of embedding features.

5. The method of claim 4, wherein the distance is a Euclidean distance.

6. The method of claim 1, further comprising:
selecting one or more convolutional blocks from the plurality of convolutional blocks,
wherein the one or more convolutional blocks are used to detect anomaly on the new data.

7. The method of claim 6, wherein the new data comprises an image, wherein the one or more convolutional blocks are selected based on one or more spatial scales of the one or more convolutional blocks and a spatial scale of the image.

8. The method of claim 1, wherein detecting anomaly on the new data comprises:
inputting the new data into at least part of the neural network model after the training;
determining an anomaly score from an output of at least part of the neural network model; and
determining whether the new data has anomaly based on the anomaly score.

9. The method of claim 8, wherein determining the anomaly score comprises:
extracting one or more new embedding features from one or more convolutional blocks in at least part of the neural network model; and
determining the anomaly score from the one or more new embedding features.

10. The method of claim 1, further comprising:
validating effectiveness of the neural network model after the training by using the neural network model after the training to perform anomaly detection on testing data having verified anomaly.

11. One or more non-transitory computer-readable media storing instructions executable to perform operations for anomaly detection, the operations comprising:
embedding training data in a latent space of a neural network model at different spatial scales, the neural network model comprising a plurality of convolutional blocks having the different spatial scales;
extracting a plurality of embedding features at the different spatial scales from the plurality of convolutional blocks;
determining a loss of the neural network model from the plurality of embedding features;
training the neural network model by updating one or more internal parameters of the neural network model based on the loss; and
detecting anomaly on new data using at least part of the trained neural network model,
wherein the training data comprises a normal datum lacking an anomaly, and the new data comprises an anomalous datum having the anomaly.

12. The one or more non-transitory computer-readable media of claim 11, wherein a spatial scale indicates a model embedding extracted at a convolutional block of the neural network model, wherein the convolutional block comprises one or more convolutional layers.

13. The one or more non-transitory computer-readable media of claim 11, wherein the training data further comprises an anomalous datum having the anomaly, wherein the normal datum and the anomalous datum in the training data have different class labels.

14. The one or more non-transitory computer-readable media of claim 11, wherein determining the loss of the neural network model comprises:
for each embedding feature, determining a distance between the embedding feature and a mean of the different spatial scales; and
accumulating distances for the plurality of embedding features.

15. The one or more non-transitory computer-readable media of claim 14, wherein the distance is a Euclidean distance.

16. The one or more non-transitory computer-readable media of claim 11, wherein the operations further comprise:
selecting one or more convolutional blocks from the plurality of convolutional blocks based on one or more spatial scales of the one or more convolutional blocks and a spatial scale of the new data,
wherein the one or more convolutional blocks are used to detect anomaly on the new data.

17. The one or more non-transitory computer-readable media of claim 11, wherein detecting anomaly on the new data comprises:
inputting the new data into at least part of the neural network model after the training;
determining an anomaly score from an output of at least part of the neural network model; and
determining whether the new data has anomaly based on the anomaly score.

18. An apparatus for anomaly detection, the apparatus comprising:
a computer processor for executing computer program instructions; and
a non-transitory computer-readable memory storing computer program instructions executable by the computer processor to perform operations comprising:
embedding training data in a latent space of a neural network model at different spatial scales, the neural network model comprising a plurality of convolutional blocks having the different spatial scales,
extracting a plurality of embedding features at the different spatial scales from the plurality of convolutional blocks,
determining a loss of the neural network model from the plurality of embedding features,
training the neural network model by updating one or more internal parameters of the neural network model based on the loss, and
detecting anomaly on new data using at least part of the trained neural network model,
wherein the training data comprises a normal datum lacking an anomaly, and the new data comprises an anomalous datum having the anomaly.

19. The apparatus of claim 18, wherein a spatial scale indicates a model embedding extracted at a convolutional block of the neural network model, wherein the convolutional block comprises one or more convolutional layers.

20. The apparatus of claim 18, wherein the operations further comprise:
selecting one or more convolutional blocks from the plurality of convolutional blocks based on one or more spatial scales of the one or more convolutional blocks and a spatial scale of the new data,
wherein the one or more convolutional blocks are used to detect anomaly on the new data.
